(19) United States
(12) Patent Application Publication
(10) Pub. No.: US 2026/0043450 A1
(43) Pub. Date: Feb. 12, 2026

(54) VIBRATORY SCREEN DAMPER SYSTEMS, METHODS, AND APPARATUS

(71) Applicant: Superior Industries, Inc., Morris, MN (US)

(72) Inventors: Edwin Sauser, Morris, MN (US); Michael Hawker, Morris, MN (US)

(21) Appl. No.: 19/292,373

(22) Filed: Aug. 6, 2025

Related U.S. Application Data
(60) Provisional application No. 63/679,918, filed on Aug. 6, 2024.

(51) Int. Cl. F16F 7/08; B07B 1/28; F16F 13/04

(52) U.S. Cl. CPC F16F 7/082; B07B 1/28; F16F 13/04; F16F 2222/04; F16F 2224/025; F16F 2228/06; F16F 2230/0005; F16F 2232/02; F16F 2232/08

(57) ABSTRACT

Vibratory screen damper apparatus, systems, and methods are described. In some embodiments, the damper comprises first and second slide portions. In some embodiments, the damper both pivots and alternately extends and retracts during vibration of the vibratory screen.

### BACKGROUND

Aggregate processing plants such as washing and/or classifying plants and related equipment are used to remove fine material and/or contaminants from and/or to classify aggregate materials.

### BRIEF DESCRIPTION OF THE DRAWINGS

FIG. 1 is a side view of an embodiment of a vibratory classifying screen.

FIG. 2 is an enlarged view of the detail area E of FIG. 1.

FIG. 3 side view of an embodiment of a damper.

FIG. 4 is a sectional view along section A-A of FIG. 3.

FIG. 5 is a perspective view of the damper of FIG. 3.

FIG. 6 is another perspective view of the damper of FIG. 3 with a portion of a side plate removed for illustrative purposes.

FIG. 7 illustrates disassembled components of the damper of FIG. 3.

### DESCRIPTION

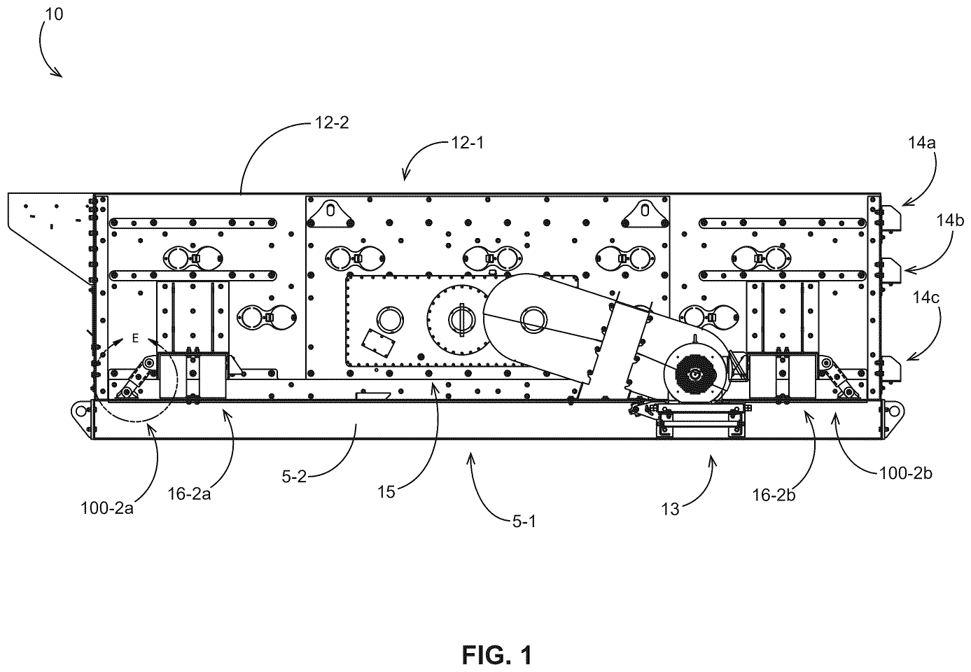

Referring to the drawings, wherein like reference numerals designate identical or corresponding parts throughout the several views, FIG. 1 illustrates an embodiment of a vibratory classifying screen 10. Screen 10 optionally comprises first and second sidewalls 12-1, 12-2 supporting one or more screen decks 14 (e.g., screen decks 14a, 14b, 14c). Each screen deck 14 is optionally substantially horizontal but in some embodiments is disposed at a downward angle or partially at a downward angle. Each screen deck 14 optionally comprises one or more types of screening media (e.g., polyurethane, wire mesh, rubber, etc.) having openings sized to allow specified sizes of material to fall therethrough. In some embodiments each screen deck 14 has a larger opening size (e.g., median opening size) than a screen deck below it such that the subset of material allowed to pass through each deck is progressively smaller as material moves vertically through the screen 10. Each sidewall 12 is optionally at least partially supported on an associated support 5 (e.g., beam, rail, etc.) such as supports 5-1, 5-2. Each sidewall 12 is optionally resiliently supported on the support 5 by an intermediate spring assembly 16. The spring or springs of each spring assembly 16 are optionally vertical or angled relative to vertical in various embodiments. Screen 10 optionally comprises one or more motors 13 operably coupled to a vibratory exciter 15 (e.g., unbalanced rotary weight assembly, unbalanced rotary weight, unbalanced shaft, etc.). In operation, the motor 13 optionally drives the vibratory exciter 15 in order to vibrate the screen 10, e.g., in a circular, elliptical, or linear pattern, etc. In operation, material deposited on the screen 10 is classified such that relatively larger material passes over the screen decks 14 and relatively smaller material passes through the screen decks 14. In some embodiments, water injection elements such as spray bars (not shown) are incorporated in screen 10 to apply water to material such as material passing over one or more decks of the screen.

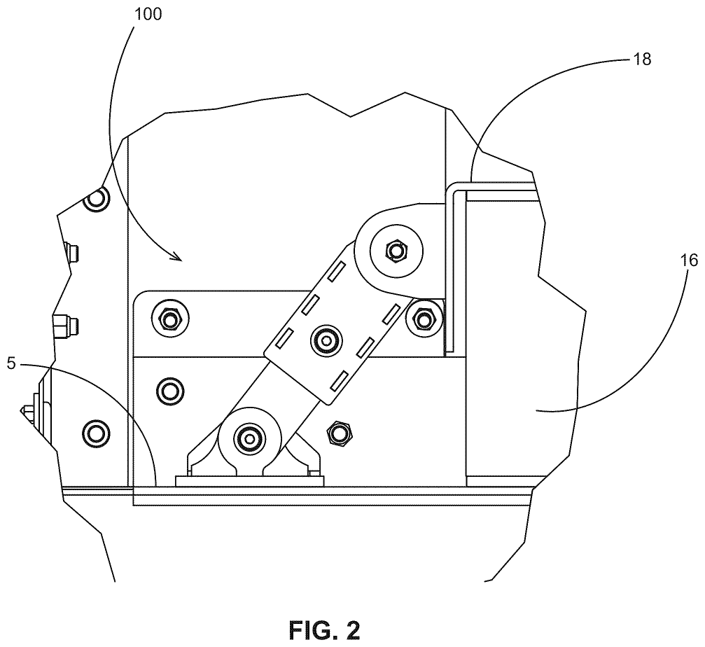

Referring to FIG. 2, an embodiment of a damper 100 is illustrated. The damper 100 is optionally coupled to the screen (e.g., to a spring housing 18, or to another suitable structure mounted to sidewall 12, etc.). The spring housing 18 is optionally at least partially supported by spring assembly 16. The spring housing 18 is optionally supported (e.g., directly supported, indirectly supported, mounted, etc.) on a sidewall 12. The spring housing 18 optionally includes a vertical portion to which the damper 100 is optionally coupled (e.g., mounted, attached, etc.). The damper 100 is optionally coupled to the support 5 or to other suitable structure. The support 5 or other suitable structure is optionally stationary or relatively stationary relative to vibration of the screen 10. A damper 100 or various damper embodiments are optionally coupled to screen 10 at multiple locations such as at or adjacent to each spring assembly 16 and/or spring housing 18. In operation, the damper 100 optionally dampens vibration of the screen 10. In operation, the damper 100 optionally dampens vibration of the screen 10 during start-up and/or shut-down, e.g., when a vibration frequency of the screen 10 moves through a frequency range such as a frequency range including a natural frequency of the screen 10.

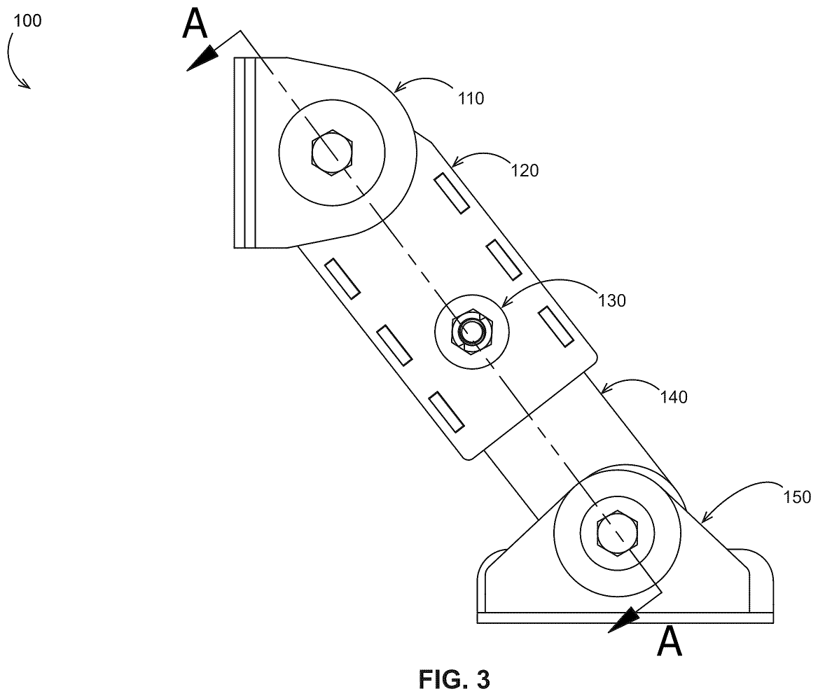

Referring to FIG. 3, the damper 100 optionally comprises one or more of a first pivot 110, a first slide portion 120, a tensioner 130, a second slide portion 140, and a second pivot 150. First pivot 110 is optionally mounted (e.g., by bolts or other fasteners) to spring housing 18 or otherwise supported indirectly or directly on sidewall 12. First slide portion 120 is optionally pivotally coupled to first pivot 110. First slide portion 120 is optionally slidingly engaged with second slide portion 140. First slide portion 120 is optionally frictionally engaged with second slide portion 140 such that sliding relative movement of slide portions 120 relative to slide portion 140 expends energy via friction, causing a damping effect. In some embodiments, the damper 100 both pivots (e.g., about pivots 110, 150) and alternately extends and retracts (e.g., by relative sliding motion of slide portions 120, 140) during vibration of the vibratory screen 10. Tensioner 130 is optionally operably coupled to slide portion 120 and slide portion 140. Tensioner 130 is optionally configured to selectively increase or decrease (i.e., adjust) a contact force between the slide portion 120 and slide portion 140. First slide portion 120 and second slide portion 140 are optionally configured to fit one another for sliding engagement, e.g., in the illustrated embodiment a portion of the second slide portion 140 slidingly fits inside an interior volume of the first slide portion 120. Second slide portion 140 is optionally pivotally coupled to second pivot 150. Second pivot 150 is optionally coupled (e.g., by bolts or other fasteners) to support 5 or otherwise supported indirectly or directly on relatively stationary structure.

During operation, as screen 10 vibrates (e.g., along a circular path, elliptical path, linear path), the damper 100 optionally both alternately extends and retracts (e.g., by relative sliding motion of the first and second slide portions 120, 140) and alternately pivots back and forth (e.g., by pivoting about the upper and lower pivots 110, 150).

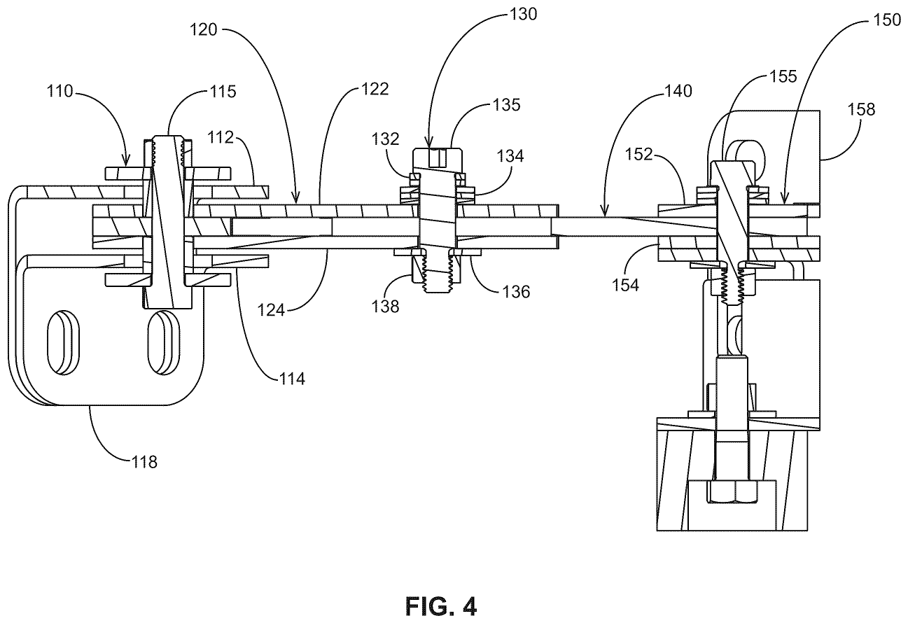

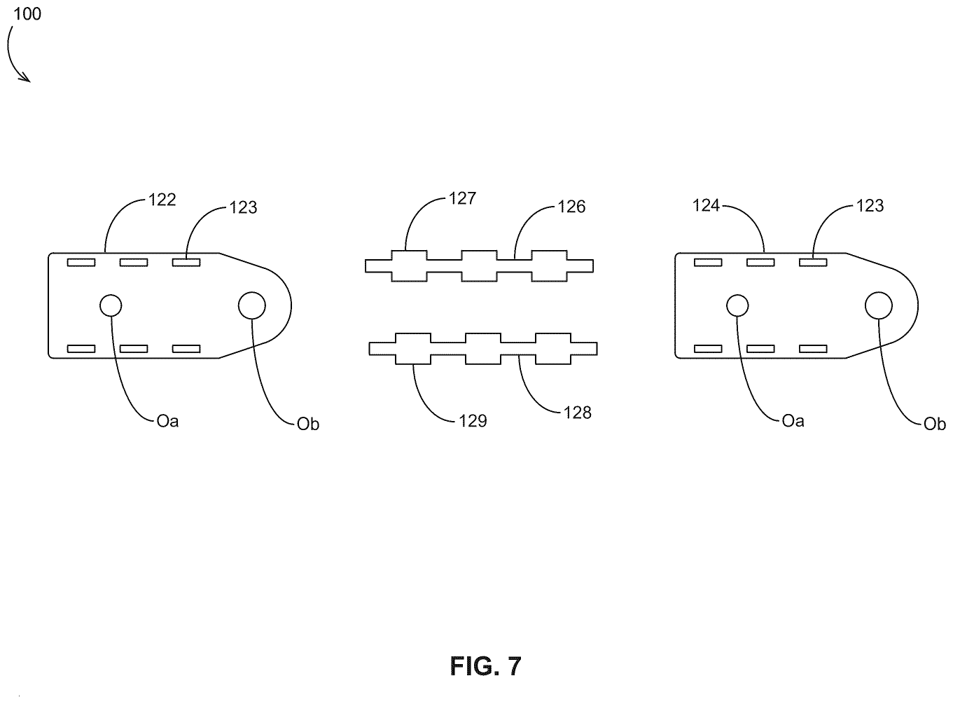

Referring to FIG. 4, the first pivot 110 optionally comprises an attachment plate 118 which is optionally mounted (e.g., by bolts or other fasteners) to spring housing 18 or otherwise supported indirectly or directly on sidewall 12. The first pivot 110 optionally comprises supports 112, 114 which are optionally supported on plate 118. The first pivot 110 optionally comprises a pin 115 which optionally extends through openings in supports 112, 114 and optionally extends through openings Ob (see FIG. 7) provided in the first slide portion. Pin 115 is optionally provided with spacers, bushings, etc. for pivotally supporting the first slide portion 120.

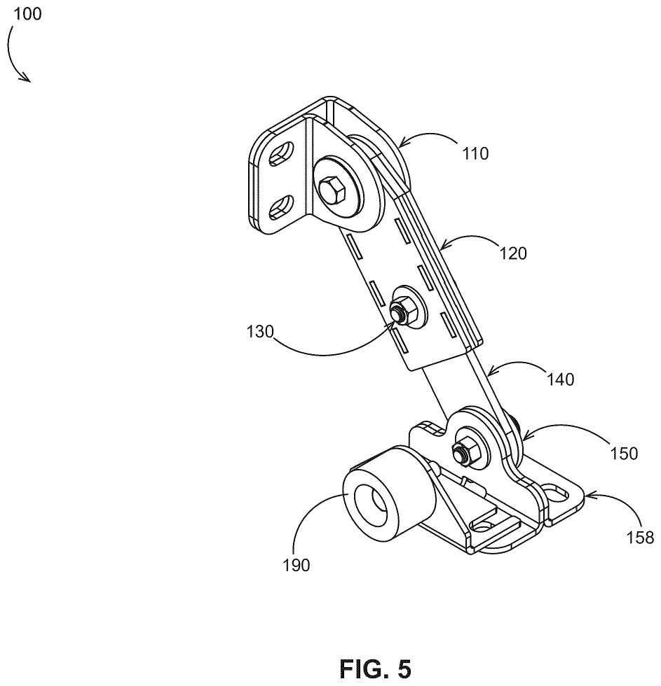

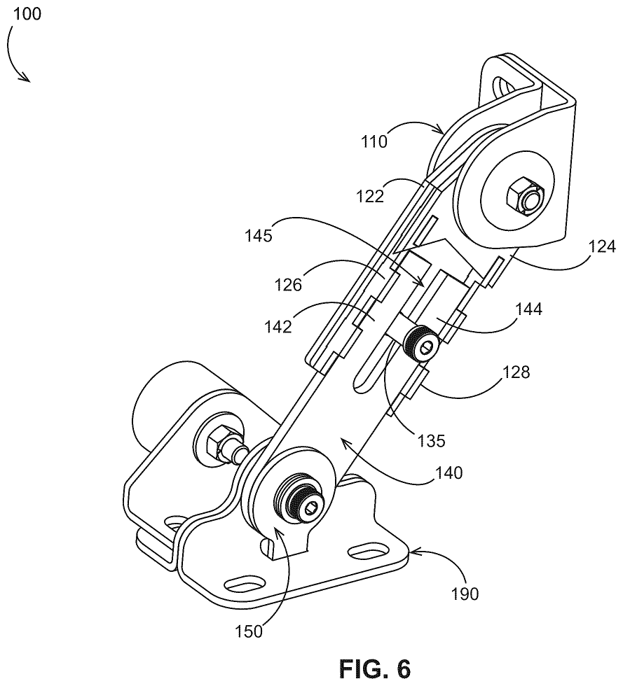

Referring to FIG. 4, the first slide portion 120 optionally comprises a first side plate 122 and a second side plate 124. Referring to FIGS. 5 and 6, the first side plate 122 and second side plate 124 are optionally disposed parallel to and laterally spaced apart from one another. The first slide portion 120 optionally comprises a first coupler 126 and second coupler 128. The first and second couplers 126, 128 optionally couple the first side plate 122 to the second side plate 124 in laterally spaced-apart relation. Referring to FIG. 7, the couplers 126, 128 optionally comprise tabs 127, 129 respectively which optionally fit into corresponding slots 123 in the side plates 122, 124. In some embodiments, the first slide portion may be assembled by inserting tabs 127, 129 into slots 123 and then optionally mounting (e.g., welding) the side plates 122, 124 to the couplers 126, 128.

Referring to FIG. 6, the second slide portion 140 optionally comprises two spaced-apart tines 142, 144 having an elongate slot 145 therebetween. The tines 142, 144 optionally extend into an interior volume of the first slide portion 120. In some embodiments, the tines 142, 144 extend between side plates 122, 124. In some embodiments, the tines 142, 144 extend between couplers 126, 128. A pin 135 of tensioner 130 optionally extends between the tines 142, 144.

Referring to FIG. 4, the tensioner 130 optionally comprises a pin 135 extending through openings Oa (see FIG. 7) in the first slide portion 120 and optionally extending through the slot 145 in the second slide portion 140. Tensioner 130 optionally comprises one or more shims 132 and a washer 136 disposed on pin 135. Tensioner 130 optionally comprises a nut 138 or other device which may be mounted to threads on the pin 135. In some embodiments, tightening or loosening nut 138 alternately modifies a tension in tensioner 130 and thus modifies the pressure and frictional force exerted by the first slide portion 120 on the second slide portion 140. In some embodiments, an axially resilient spring element 134 (e.g., spring washer, spring disc, conical spring washer, Belleville washer, etc.) is disposed between an annular shoulder of a head of pin 135 and the first slide portion 120. Spring element 134 is optionally configured to resiliently maintain tension in tensioner 130 and thus resiliently maintain a a compressive force between the first slide portion 120 and second slide portion 140.

Referring to FIG. 4, the second pivot 150 optionally comprises an attachment plate 158 which is optionally coupled (e.g., by bolts or other fasteners) to support 5 or otherwise supported indirectly or directly on relatively stationary structure. The second pivot 150 optionally comprises supports 152, 154 which are optionally supported on plate 158. The second pivot 150 optionally comprises a pin 155 which optionally extends through openings in supports 152, 154.

Referring to FIG. 6, it should be appreciated that various materials are used in the components of various embodiments of the damper 100. In some embodiments, first slide portion 120 is made of a first metal (e.g., mild steel, stainless steel, steel, etc.) and second slide portion 140 is made of a second metal (e.g., brass, steel, etc.). In one embodiment first slide portion 120 is made of steel and second slide portion 140 is made of brass. In some embodiments, both slide portions 120, 140 are made of the same material (e.g., stainless steel, steel, aluminum, etc.). In some of the embodiments described in this paragraph, some or all other components are optionally made of metal (e.g., steel, mild steel, stainless steel, aluminum, etc.).

In some alternative embodiments, the first and second slide portions are reversed such that the first slide portion is pivotally coupled to the second pivot and the second slide portion is pivotally coupled to the first pivot. In some alternative embodiments, the first and second slide portion optionally comprise a piston and cylinder arrangement or other suitable arrangement.

In some embodiments a bumper 190 is provided on or adjacent to damper 100 and disposed to between the damper 100 and sidewall 12. In some embodiments the bumper 190 comprises rubber, polyurethane, urethane, nylon, or other suitable material.

In various embodiments, vibratory classifying screens comprising damper embodiments described herein may be self-standing and/or may be incorporated in a plant having other equipment thereon (e.g., crushers, further vibratory classifier screens, vibratory feeders, crushers, impactors, hoppers, further conveyors, etc.). The conveyor embodiments and/or plant embodiments including such impact cradle embodiments may be stationary or portable (e.g., supported on skids, tracks, or wheels) according to various embodiments.

Unless otherwise indicated, reference numerals recited with the suffixes −1 and −2 indicate that in at least one of various embodiments, the objects of the reference numerals comprise a corresponding (e.g., structurally similar, structurally identical, identical, symmetrical, similar, functionally similar, functionally identical, etc.) pair. In any instance where a reference numeral is shown with one of the suffixes −1 or −2 and the reference numeral with the other suffix is omitted from the drawings and/or the written description, it is hereby positively recited that there is at least one embodiment including the unwritten, unlabeled, and/or unillustrated element.

Unless otherwise indicated, reference numerals recited with sequential lower-case letter suffixes (e.g., a, b, c, etc.) indicate that the objects of the reference numerals comprise a series of corresponding (e.g., structurally similar, structurally identical, identical, similar, functionally similar, functionally identical, etc.) objects. In any instance where a letter suffix (e.g., c) is used and one or more of the preceding letter suffixes (e.g., a, b) are omitted from the drawings and/or the written description, it is hereby positively recited that there is at least one embodiment including the omitted corresponding objects in the series.

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A damper for a vibratory screen, comprising:
a first pivot;
a first slide portion pivotally coupled to said first pivot;
a second slide portion slidingly engaged with said first slide portion; and
a second pivot, said second slide portion being pivotally coupled to said second pivot.

2. The damper of claim 1, further comprising a tensioner operably coupled to the first slide portion and the second slide portion, the tensioner configured to adjust a contact force between the first slide portion and the second slide portion.

3. The damper of claim 2, wherein the tensioner comprises a pin extending through openings in the first slide portion and an elongate slot in the second slide portion, a nut mounted to the pin, and an axially resilient spring element disposed between a head of the pin and the first slide portion.

4. The damper of claim 1, wherein the first slide portion comprises a first side plate and a second side plate disposed parallel to and laterally spaced apart from one another, and a first coupler and a second coupler coupling the first side plate to the second side plate.

5. The damper of claim 4, wherein the second slide portion comprises two spaced-apart tines defining an elongate slot therebetween, the tines extending into an interior volume between the first side plate and the second side plate of the first slide portion.

6. The damper of claim 1, wherein the first pivot comprises an attachment plate configured to be mounted to a spring housing of the vibratory screen, and a pin extending through supports on the attachment plate and through openings in the first slide portion.

7. The damper of claim 1, wherein the second pivot comprises an attachment plate configured to be mounted to a stationary support, and a pin extending through supports on the attachment plate and through openings in the second slide portion.

8. The damper of claim 1, wherein the first slide portion is made of steel and the second slide portion is made of brass.

9. The damper of claim 1, wherein the first slide portion and the second slide portion are both made of stainless steel.

10. The damper of claim 1, further comprising a bumper disposed adjacent to the damper, the bumper comprising a material selected from the group consisting of rubber, polyurethane, urethane, and nylon.

11. The damper of claim 1, wherein the damper is configured to dampen vibration of the vibratory screen during at least one of start-up and shut-down when a vibration frequency of the vibratory screen passes through a natural frequency of the vibratory screen.

12. The damper of claim 1, wherein the first slide portion and the second slide portion are configured to alternately extend and retract via relative sliding motion and to pivot about the first pivot and the second pivot during vibration of the vibratory screen.

13. The damper of claim 1, further comprising:
a tensioner, said tensioner resiliently maintaining a compressive force between said first and second slide portions, wherein said tensioner is configured to selectively modify said compressive force.

14. A vibratory screen, comprising:
at least a first screen deck;
a sidewall at least partially supporting said screen deck; and
a damper operably coupled to said sidewall, said damper comprising:
a first pivot;
a first slide portion pivotally coupled to said first pivot;
a second slide portion slidingly engaged with said first slide portion; and
a second pivot, said second slide portion being pivotally coupled to said second pivot.

15. The vibratory screen of claim 14, wherein said damper further comprises:
a tensioner, said tensioner resiliently maintaining a compressive force between said first and second slide portions, wherein said tensioner is configured to selectively modify said compressive force.

16. A method of damping vibration of a vibratory screen, comprising:
pivoting a damper assembly having first and second portions; and
slidingly moving said first and second portions relative to one another, whereby energy is expended by frictional engagement of said first and second portions.

17. The method of claim 16, further comprising adjusting a contact force between the first and second portions using a tensioner operably coupled to the first and second portions.

18. The method of claim 17, wherein adjusting the contact force comprises tightening or loosening a nut on a pin of the tensioner, the pin extending through openings in the first portion and an elongate slot in the second portion, with an axially resilient spring element disposed between a head of the pin and the first portion.

19. The method of claim 16, wherein pivoting the damper assembly comprises pivoting the first portion about a first pivot mounted to a spring housing of the vibratory screen and pivoting the second portion about a second pivot mounted to a stationary support.

20. The method of claim 16, wherein slidingly moving the first and second portions comprises sliding two spaced-apart tines of the second portion within an interior volume defined by a first side plate and a second side plate of the first portion.
